(19) United States
(12) Patent Application Publication
(10) Pub. No.: US 2026/0113767 A1
(43) Pub. Date: Apr. 23, 2026

(54) CAPABILITY INDICATION METHOD AND APPARATUS, CAPABILITY DETERMINATION METHOD AND APPARATUS, AND COMMUNICATION APPARATUS AND STORAGE MEDIUM

(71) Applicant: Beijing Xiaomi Mobile Software Co., Ltd., Beijing (CN)

(72) Inventor: Lei WANG, Beijing (CN)

(73) Assignee: Beijing Xiaomi Mobile Software Co., Ltd., Beijing (CN)

(21) Appl. No.: 19/115,658

(22) PCT Filed: Sep. 26, 2022
(86) PCT No.: PCT/CN2022/121497

§ 371 Date: Mar. 26, 2025

(51) Int. Cl. H04W 72/51; H04L 5/14; H04W 72/12

(52) U.S. Cl. CPC H04W 72/51; H04L 5/14; H04W 72/12

(57) ABSTRACT

A capability indication method, a capability determination method, a capability indication system, communication apparatuses, and storage mediums are provided. The capability indication method includes: sending capability support indication information to a network device, wherein the capability support indication information indicates a condition of the terminal being capable of supporting full-duplex communication.

### CROSS-REFERENCE TO RELATED APPLICATIONS

The present disclosure is a U.S. national phase of PCT Application No. PCT/CN2022/121497 filed on Sep. 26, 2022, the content of which is hereby incorporated by reference in its entirety.

### TECHNICAL FIELD

The present disclosure relates to a field of communication technologies, and in particular to a capability indication method, a capability determination method, a capability indication apparatus, a capability determination apparatus, communication apparatuses, and computer-readable storage mediums.

### BACKGROUND

Full-duplex communication is proposed in related technologies to improve a communication efficiency. For example, a network device configures an uplink (UL) subband for a terminal in a frequency domain resource corresponding to a downlink (DL) slot, so that the terminal may send information to the network device in the uplink subband in the downlink slot, and may receive information sent by the network device in a frequency domain resource other than the uplink subband in the downlink slot, thereby implementing the full-duplex communication in the downlink slot.

### SUMMARY

According to a first aspect of the embodiments of the present disclosure, a capability indication method is provided. The method is performed by a terminal and includes: sending capability support indication information to a network device, where the capability support indication information indicates a condition of the terminal being capable of supporting full-duplex communication.

According to a second aspect of the embodiments of the present disclosure, a capability determination method is provided. The method is performed by a network device and includes: determining, according to a capability support indication information sent by a terminal, a condition of the terminal being capable of supporting full-duplex communication.

According to a third aspect of the embodiments of the present disclosure, a capability indication system is provided. The capability indication system includes a terminal and a network device, where the terminal is configured to implement the capability indication method, and the network device is configured to implement the capability determination method.

According to a fourth aspect of the embodiments of the present disclosure, a communication apparatus is provided. The communication apparatus includes: a processor; and a memory storing a computer program, where when the computer program is executed by the processor, the capability indication method is implemented.

According to a fifth aspect of the embodiments of the present disclosure, a communication apparatus is provided. The communication apparatus includes: a processor; and a memory storing a computer program, where when the computer program is executed by the processor, the capability determination method is implemented.

According to a sixth aspect of the embodiments of the present disclosure, a computer-readable storage medium is provided. The computer-readable storage medium is configured to store a computer program; where when the computer program is executed by a processor, the capability indication method is implemented.

According to a seventh aspect of the embodiments of the present disclosure, a computer-readable storage medium is provided. The computer-readable storage medium is configured to store a computer program; where when the computer program is executed by a processor, the capability determination method is implemented.

### BRIEF DESCRIPTION OF DRAWINGS

To more clearly describe technical solutions in embodiments of the present disclosure, accompanying drawings that need to be used in description of the embodiments will be briefly described below. The accompanying drawings described below are for only some of the embodiments of the present disclosure, and those skilled in the art may also obtain other drawings based on these accompanying drawings without any creative efforts.

FIG. 1 is a schematic flowchart of a capability indication method shown according to an embodiment of the present disclosure.

FIG. 2 is a schematic flowchart of another capability indication method shown according to an embodiment of the present disclosure.

FIG. 3 is a schematic flowchart of still another capability indication method shown according to an embodiment of the present disclosure.

FIG. 4 is a schematic flowchart of still another capability indication method shown according to an embodiment of the present disclosure.

FIG. 5 is a schematic flowchart of a capability determination method shown according to an embodiment of the present disclosure.

FIG. 6 is a schematic block diagram of a capability indication apparatus shown according to an embodiment of the present disclosure.

FIG. 7 is a schematic block diagram of a capability determination apparatus shown according to an embodiment of the present disclosure.

FIG. 8 is a schematic block diagram of a capability determination apparatus shown according to an embodiment of the present disclosure.

FIG. 9 is a schematic block diagram of a capability indication apparatus shown according to an embodiment of the present disclosure.

### DETAILED DESCRIPTION

The technical solutions in the embodiments of the present disclosure will be described clearly and completely below in combination with the accompanying drawings in the embodiments of the present disclosure. The described embodiments are merely a part of and not all of the embodiments of the present disclosure. All other embodiments obtained by those skilled in the art based on the embodiments of the present disclosure without creative efforts shall fall within the scope of protection of the present disclosure.

Terms used in the embodiments of the present disclosure are only for a purpose of describing specific embodiments, and are not intended to limit the embodiments of the present disclosure. Singular forms, “a/an” and “the” used in the embodiments and the appended claims of the present disclosure are also intended to include majority forms, unless the context clearly indicates other meanings. It should also be understood that the term “and/or” used herein refers to and includes any or all possible combinations of one or more related listed items.

It should be understood that although terms, such as “first,” “second,” “third,” etc., may be used in the embodiments of the present disclosure to describe various information, such information should not be limited by these terms. These terms are only used to distinguish a same type of information from each other. For example, without departing from the scope of the embodiments of the present disclosure, first information can also be referred to as second information, and similarly, the second information can also be referred to as the first information. Depending on the context, the term “if” used herein may be interpreted as “when,” “while,” or “in response to determining.”

For purposes of brevity and ease of understanding, the used term is “greater than,” “less than,” “higher than,” or “lower than” when representing a size relationship herein. However, those skilled in the art may understand that the term “greater than” also covers the meaning of “greater than or equal to”, and the term “less than” also covers the meaning of “less than or equal to”; the term “higher than” covers the meaning of “higher than or equal to”, and the term “lower than” also covers the meaning of “lower than or equal to”.

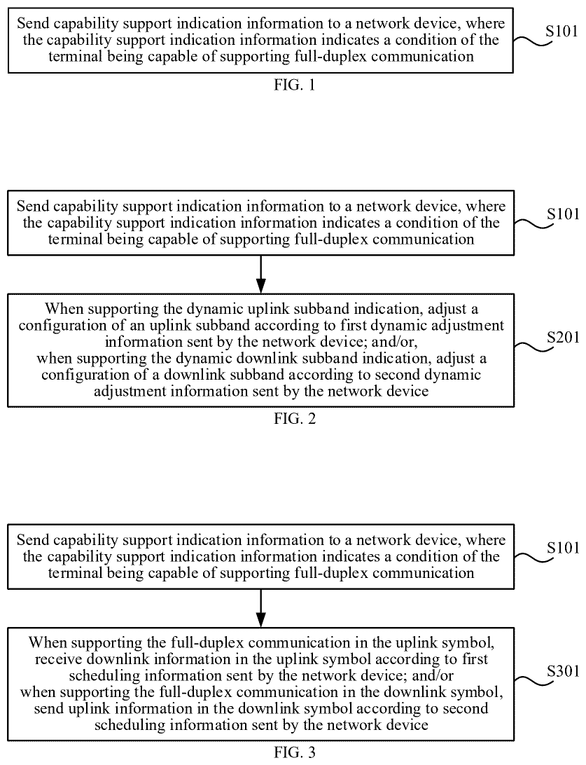

FIG. 1 is a schematic flowchart of a capability indication method shown according to an embodiment of the present disclosure. The capability indication method shown in this embodiment may be performed by a terminal, and the terminal includes but is not limited to a communication apparatus, such as a mobile phone, a tablet computer, a wearable device, a sensor, an Internet of Things device, etc. The terminal may communicate with a network device, and the network device includes but is not limited to a network device, such as a base station, a core network, etc., in a communication system, such as 4G, 5G, 6G, etc.

As shown in FIG. 1, the capability indication method may include the following step S101.

At step S101, capability support indication information is sent to a network device, where the capability support indication information indicates a condition of the terminal being capable of supporting full-duplex communication.

According to an embodiment of the present disclosure, the terminal may send the capability support indication information to the network device, and notify, with the capability support indication information, the network device of the condition of the terminal being capable of supporting full-duplex communication, so that the network device may appropriately configure the terminal according to the condition of the terminal being capable of supporting full-duplex communication. For example, when it is determined that the terminal supports the full-duplex communication, the resource for the full-duplex communication may be configured for the terminal, and when it is determined that the terminal does not support the full-duplex communication, the resource for non-full-duplex communication may be configured for the terminal.

In an embodiment, the capability support indication information indicates at least one of: whether supporting the full-duplex communication; whether supporting a dynamic subband indication; whether supporting the full-duplex communication in a granularity of a symbol within a time domain, where the symbol may be an orthogonal frequency division multiplexing (OFDM) symbol; or whether supporting semi-static communication in a dynamic flexible symbol.

In an embodiment, supporting, by the terminal, the full-duplex communication includes at least one of the following 4 conditions: the terminal supports sending information to the network device in an uplink subband of a downlink slot; the terminal supports receiving information sent by a network device in a downlink subband of an uplink slot; the terminal supports sending semi-static uplink information to the network device in the dynamic flexible symbol; or the terminal supports receiving semi-static downlink information sent by the network device in the dynamic flexible symbol.

The granularity indicated by the capability support indication information reported by the terminal may be whether the terminal supports the full-duplex communication. Therefore, supporting the full-duplex communication is supporting the 4 conditions, and not-supporting the full-duplex communication is not-supporting the 4 conditions. The granularity indicated by the capability support indication information reported by the terminal may also be at least one of the 4 conditions. Therefore, according to the capability support indication information, it may be determined that the terminal specifically supports one or more of the 4 conditions.

In an embodiment, whether supporting the dynamic subband indication includes at least one of: whether supporting a dynamic uplink subband indication; or whether supporting a dynamic downlink subband indication.

FIG. 2 is a schematic flowchart of another capability indication method shown according to an embodiment of the present disclosure. As shown in FIG. 2, the method further includes step S201.

At step S201, when supporting the dynamic uplink subband indication, a configuration of an uplink subband is adjusted according to first dynamic adjustment information sent by the network device; and/or, when supporting the dynamic downlink subband indication, a configuration of a downlink subband is adjusted according to second dynamic adjustment information sent by the network device.

In an embodiment, supporting, by the terminal, the dynamic uplink subband indication includes: supporting, by the terminal, the network device to dynamically adjust the uplink subband; and therefore, in the case where the network device determines that the terminal supports the dynamic uplink subband indication, the network device may send the first dynamic adjustment information to the terminal, and dynamically adjust the configuration of the uplink subband with the first dynamic adjustment information. If the network device determines that the terminal does not support the dynamic uplink subband indication, the network device does not send the first dynamic adjustment information to the terminal.

Supporting, by the terminal, the dynamic downlink subband indication includes: supporting, by the terminal, the network device to dynamically adjust the downlink subband; and therefore, in the case where the network device determines that the terminal supports the dynamic downlink subband indication, the network device may send the second dynamic adjustment information to the terminal, and dynamically adjust the configuration of the downlink subband with the second dynamic adjustment information. If the network device determines that the terminal does not support the dynamic downlink subband indication, the network device does not send the second dynamic adjustment information to the terminal.

It should be noted that after determining that the terminal supports the dynamic uplink subband indication, the network device may further determine a current network condition, for example, an interference condition, a service condition, or a load condition, etc., and determine the first dynamic adjustment information according to the current network condition, so that the adjusted configuration of the uplink subband is applicable to the current network condition.

Similarly, after determining that the terminal supports the dynamic downlink subband indication, the network device may further determine a current network condition, for example, an interference condition, a service condition, or a load condition, etc., and determine the second dynamic adjustment information according to the current network condition, so that the adjusted configuration of the downlink subband is applicable to the current network condition.

The first dynamic adjustment information and the second dynamic adjustment information may be dynamic information, for example, a slot format indication (SFI) or downlink control information (DCI), etc. The configuration of the subband includes but is not limited to a frequency domain start position of the subband, a frequency domain range of the subband, etc.

In an embodiment, whether supporting the full-duplex communication in a granularity of a symbol within a time domain includes at least one of: whether supporting the full-duplex communication in an uplink symbol; or whether supporting the full-duplex communication in a downlink symbol.

FIG. 3 is a schematic flowchart of still another capability indication method shown according to an embodiment of the present disclosure. As shown in FIG. 3, the method further includes step S301.

At step S301, when supporting the full-duplex communication in the uplink symbol, downlink information is received in the uplink symbol according to first scheduling information sent by the network device; and/or when supporting the full-duplex communication in the downlink symbol, uplink information is sent in the downlink symbol according to second scheduling information sent by the network device.

In an embodiment, supporting, by the terminal, the full-duplex communication in the uplink symbol includes supporting, by the terminal, the network device scheduling the terminal to perform downlink transmission in the uplink symbol; therefore, in the case of determining that the terminal supports the full-duplex communication in the uplink symbol, the network device may send first scheduling information to the terminal, and schedule, with the first scheduling information, the terminal to perform downlink transmission in the uplink symbol. If the network device determines that the terminal does not support the full-duplex communication in the uplink symbol, the network device does not send the first scheduling information to the terminal.

Supporting, by the terminal, the full-duplex communication in the downlink symbol includes supporting, by the terminal, the network device scheduling the terminal to perform uplink transmission in the downlink symbol; therefore, in the case of determining that the terminal supports the full-duplex communication in the downlink symbol, the network device may send second scheduling information to the terminal, and schedule, with the second scheduling information, the terminal to perform uplink transmission in the downlink symbol. If the network device determines that the terminal does not support the full-duplex communication in the downlink symbol, the network device does not send the second scheduling information to the terminal.

In an embodiment, whether supporting the semi-static communication in the dynamic flexible symbol includes at least one of: whether supporting sending semi-static uplink information in the dynamic flexible symbol; or whether supporting receiving semi-static downlink information in the dynamic flexible symbol.

FIG. 4 is a schematic flowchart of still another capability indication method shown according to an embodiment of the present disclosure. As shown in FIG. 4, the method further includes step S401.

At step S401, when supporting sending the semi-static uplink information in the dynamic flexible symbol, the semi-static uplink information is sent in the dynamic flexible symbol according to first indication information sent by the network device; and/or when supporting receiving the semi-static downlink information in the dynamic flexible symbol, the semi-static downlink information is received in the dynamic flexible symbol according to second indication information sent by the network device.

In an embodiment, supporting, by the terminal, sending the semi-static uplink information in the dynamic flexible symbol includes: supporting, by the terminal, the network device to instruct the terminal to send the semi-static uplink information in the dynamic flexible symbol; therefore, in the case of determining that the terminal supports sending the semi-static uplink information in the dynamic flexible symbol, the network device may send first indication information to the terminal, and instruct, with the first indication information, the terminal to send the semi-static uplink information in the dynamic flexible symbol.

If the network device determines that the terminal does not support sending the semi-static uplink information in the dynamic flexible symbol, the network device may not send the first indication information to the terminal, or the network device may send the first indication information to the terminal, but the terminal may ignore the first indication information in the dynamic flexible symbol. In this case, the network device does not receive the semi-static uplink information sent by the terminal in the dynamic flexible symbol.

Supporting, by the terminal, receiving the semi-static downlink information in the dynamic flexible symbol includes: supporting, by the terminal, the network device to instruct the terminal to receive the semi-static downlink information in the dynamic flexible symbol; therefore, in the case of determining that the terminal supports receiving the semi-static downlink information in the dynamic flexible symbol, the network device may send second indication information to the terminal, and instruct, with the second indication information, the terminal to receive the semi-static uplink information in the dynamic flexible symbol.

If the network device determines that the terminal does not support receiving the semi-static downlink information in the dynamic flexible symbol, the network device does not send the second indication information to the terminal, or the network device may send the second indication information to the terminal, but the terminal may ignore the second indication information in the dynamic flexible symbol. In this case, the network device may not send the semi-static downlink information to the terminal in the dynamic flexible symbol.

The first indication information and the second indication information include but are not limited to radio resource control (RRC) signaling.

In an embodiment, the semi-static uplink information includes at least one of: a configured grant (CG) physical uplink shared channel (PUSCH) including a type 1 and a type 2; a periodic physical uplink control channel (PUCCH); or a periodic channel sounding reference signal (SRS).

In an embodiment, the semi-static downlink information includes at least one of: a semi-persistent scheduling physical downlink shared channel (PDSCH); a periodic channel state information reference signal (CSI-RS); a periodic positioning reference signal (PRS); a periodic timing reference signal (TRS); or a periodic synchronization signal block (SSB).

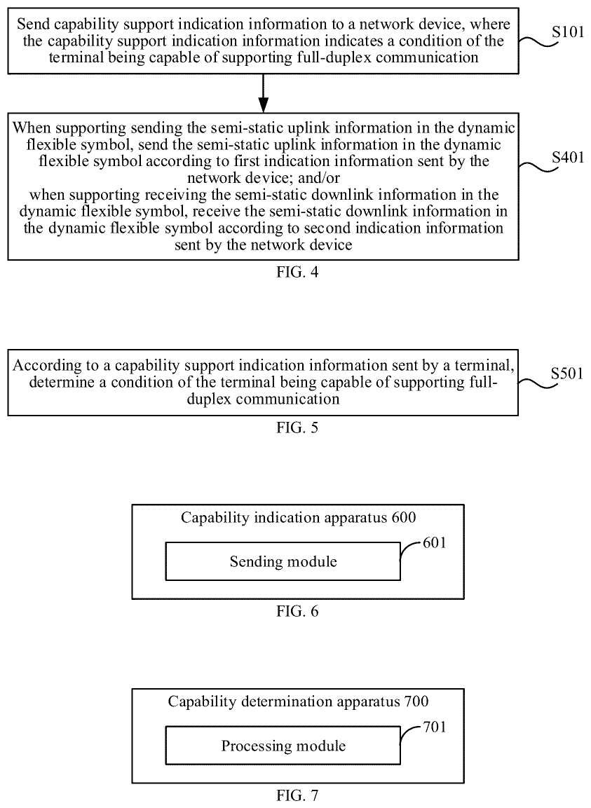

FIG. 5 is a schematic flowchart of a capability determination method shown according to an embodiment of the present disclosure. The capability determination method in this embodiment may be performed by a network device. The network device may communicate with a terminal. The network device includes but is not limited to a base station in a communication system, such as a 4G base station, a 5G base station, a 6G base station, etc. The terminal includes but is not limited to a communication apparatus, such as a mobile phone, a tablet computer, a wearable device, a sensor, an Internet of Things device, etc.

As shown in FIG. 5, the capability determination method may include the following step S501.

At step S501, according to a capability support indication information sent by a terminal, a condition of the terminal being capable of supporting full-duplex communication is determined.

According to an embodiment of the present disclosure, the terminal may send the capability support indication information to the network device, and the network device may determine, according to the capability support indication information, the network device of the condition of the terminal being capable of supporting full-duplex communication, so that the network device may appropriately configure the terminal according to the condition of the terminal being capable of supporting full-duplex communication. For example, when it is determined that the terminal supports the full-duplex communication, the resource for the full-duplex communication may be configured for the terminal, and when it is determined that the terminal does not support the full-duplex communication, the resource for non-full-duplex communication may be configured for the terminal.

In an embodiment, the capability support indication information indicates at least one of: whether supporting the full-duplex communication; whether supporting a dynamic subband indication; whether supporting the full-duplex communication in a granularity of a symbol within a time domain, where the symbol may be the OFDM symbol; or whether supporting semi-static communication in a dynamic flexible symbol.

In an embodiment, supporting, by the terminal, the full-duplex communication includes at least one of the following 4 conditions: the terminal supports sending information to the network device in an uplink subband of a downlink slot; the terminal supports receiving information sent by a network device in a downlink subband of an uplink slot; the terminal supports sending semi-static uplink information to the network device in the dynamic flexible symbol; or the terminal supports receiving semi-static downlink information sent by the network device in the dynamic flexible symbol.

The granularity indicated by the capability support indication information reported by the terminal may be whether the terminal supports the full-duplex communication. Therefore, supporting the full-duplex communication is supporting the 4 conditions, and not-supporting the full-duplex communication is not-supporting the 4 conditions. The granularity indicated by the capability support indication information reported by the terminal may also be at least one of the 4 conditions. Therefore, according to the capability support indication information, it may be determined that the terminal specifically supports one or more of the 4 conditions.

In an embodiment, whether supporting the dynamic subband indication includes at least one of: whether supporting a dynamic uplink subband indication; or whether supporting a dynamic downlink subband indication.

In an embodiment, the method further includes: sending, when determining that the terminal supports the dynamic uplink subband indication, first dynamic adjustment information to the terminal, where the first dynamic adjustment information is for adjusting a configuration of an uplink subband; and/or sending, when determining that the terminal supports the dynamic downlink subband indication, second dynamic adjustment information to the terminal, where the second dynamic adjustment information is for adjusting a configuration of a downlink subband.

In an embodiment, supporting, by the terminal, the dynamic uplink subband indication includes: supporting, by the terminal, the network device to dynamically adjust the uplink subband; and therefore, in the case where the network device determines that the terminal supports the dynamic uplink subband indication, the network device may send the first dynamic adjustment information to the terminal, and dynamically adjust the configuration of the uplink subband with the first dynamic adjustment information. If the network device determines that the terminal does not support the dynamic uplink subband indication, the network device does not send the first dynamic adjustment information to the terminal.

Supporting, by the terminal, the dynamic downlink subband indication includes: supporting, by the terminal, the network device to dynamically adjust the downlink subband; and therefore, in the case where the network device determines that the terminal supports the dynamic downlink subband indication, the network device may send the second dynamic adjustment information to the terminal, and dynamically adjust the configuration of the downlink subband with the second dynamic adjustment information. If the network device determines that the terminal does not support the dynamic downlink subband indication, the network device does not send the second dynamic adjustment information to the terminal.

It should be noted that after determining that the terminal supports the dynamic uplink subband indication, the network device may further determine a current network condition, for example, an interference condition, a service condition, or a load condition, etc., and determine the first dynamic adjustment information according to the current network condition, so that the adjusted configuration of the uplink subband is applicable to the current network condition.

Similarly, after determining that the terminal supports the dynamic downlink subband indication, the network device may further determine a current network condition, for example, an interference condition, a service condition, or a load condition, etc., and determine the second dynamic adjustment information according to the current network condition, so that the adjusted configuration of the downlink subband is applicable to the current network condition.

The first dynamic adjustment information and the second dynamic adjustment information may be dynamic information, for example, a slot format indication or downlink control information, etc. The configuration of the subband includes but is not limited to a frequency domain start position of the subband, a frequency domain range of the subband, etc.

In an embodiment, whether supporting the full-duplex communication in a granularity of a symbol within a time domain includes at least one of: whether supporting the full-duplex communication in an uplink symbol; or whether supporting the full-duplex communication in a downlink symbol.

In an embodiment, the method further includes: sending, when determining that the terminal supports the full-duplex communication in the uplink symbol, first scheduling information to the terminal, where the first scheduling information is for scheduling the terminal to receive downlink information in the uplink symbol; and/or sending, when determining that the terminal supports the full-duplex communication in the downlink symbol, second scheduling information to the terminal, where the second scheduling information is for scheduling the terminal to receive uplink information in the downlink symbol.

In an embodiment, supporting, by the terminal, the full-duplex communication in the uplink symbol includes supporting, by the terminal, the network device scheduling the terminal to perform downlink transmission in the uplink symbol; therefore, in the case of determining that the terminal supports the full-duplex communication in the uplink symbol, the network device may send first scheduling information to the terminal, and schedule, with the first scheduling information, the terminal to perform downlink transmission in the uplink symbol. If the network device determines that the terminal does not support the full-duplex communication in the uplink symbol, the network device does not send the first scheduling information to the terminal.

Supporting, by the terminal, the full-duplex communication in the downlink symbol includes supporting, by the terminal, the network device scheduling the terminal to perform uplink transmission in the downlink symbol; therefore, in the case of determining that the terminal supports the full-duplex communication in the downlink symbol, the network device may send second scheduling information to the terminal, and schedule, with the second scheduling information, the terminal to perform uplink transmission in the downlink symbol. If the network device determines that the terminal does not support the full-duplex communication in the downlink symbol, the network device does not send the second scheduling information to the terminal.

In an embodiment, whether supporting the semi-static communication in the dynamic flexible symbol includes at least one of: whether supporting sending semi-static uplink information in the dynamic flexible symbol; or whether supporting receiving semi-static downlink information in the dynamic flexible symbol.

In an embodiment, the method further includes: sending, when determining that the terminal supports sending the semi-static uplink information in the dynamic flexible symbol, first indication information to the terminal, where the first indication information is for instructing the terminal to send the semi-static uplink information in the dynamic flexible symbol; and/or sending, when determining that the terminal supports receiving the semi-static downlink information in the dynamic flexible symbol, second indication information to the terminal, where the second indication information is for instructing the terminal to receive the semi-static downlink information in the dynamic flexible symbol.

In an embodiment, supporting, by the terminal, sending the semi-static uplink information in the dynamic flexible symbol includes: supporting, by the terminal, the network device to instruct the terminal to send the semi-static uplink information in the dynamic flexible symbol; therefore, in the case of determining that the terminal supports sending the semi-static uplink information in the dynamic flexible symbol, the network device may send first indication information to the terminal, and instruct, with the first indication information, the terminal to send the semi-static uplink information in the dynamic flexible symbol.

If the network device determines that the terminal does not support sending the semi-static uplink information in the dynamic flexible symbol, the network device may not send the first indication information to the terminal, or the network device may send the first indication information to the terminal, but the terminal may ignore the first indication information in the dynamic flexible symbol. In this case, the network device does not receive the semi-static uplink information sent by the terminal in the dynamic flexible symbol.

Supporting, by the terminal, receiving the semi-static downlink information in the dynamic flexible symbol includes: supporting, by the terminal, the network device to instruct the terminal to receive the semi-static downlink information in the dynamic flexible symbol; therefore, in the case of determining that the terminal supports receiving the semi-static downlink information in the dynamic flexible symbol, the network device may send second indication information to the terminal, and instruct, with the second indication information, the terminal to receive the semi-static uplink information in the dynamic flexible symbol.

If the network device determines that the terminal does not support receiving the semi-static downlink information in the dynamic flexible symbol, the network device does not send the second indication information to the terminal, or the network device may send the second indication information to the terminal, but the terminal may ignore the second indication information in the dynamic flexible symbol. In this case, the network device may not send the semi-static downlink information to the terminal in the dynamic flexible symbol.

The first indication information and the second indication information include but are not limited to radio resource control signaling.

In an embodiment, the semi-static uplink information includes at least one of: a configured grant physical uplink shared channel including a type 1 and a type 2; a periodic physical uplink control channel; or a periodic channel sounding reference signal.

In an embodiment, the semi-static downlink information includes at least one of: a semi-persistent scheduling physical downlink shared channel; a periodic channel state information reference signal; a periodic positioning reference signal; a periodic timing reference signal; or a periodic synchronization signal block.

An embodiment of the present disclosure further provides a capability indication system, including a terminal and a network device, where the terminal is configured to implement the capability indication method in any one of the embodiments, and the network device is configured to implement the capability determination method in any one of the embodiments.

Corresponding to the embodiments of the capability indication method and the capability determination method, the present disclosure further provides embodiments of a capability indication apparatus and a capability determination apparatus.

FIG. 6 is a schematic block diagram of a capability indication apparatus 600 shown according to an embodiment of the present disclosure. The capability indication apparatus 600 shown in this embodiment may be a terminal, or an apparatus formed by modules in a terminal. The terminal includes but is not limited to a communication apparatus, such as a mobile phone, a tablet computer, a wearable device, a sensor, an Internet of Things device, etc. The terminal may communicate with a network device, and the network device includes but is not limited to a network device, such as a base station, a core network, etc., in a communication system, such as 4G, 5G, 6G, etc.

As shown in FIG. 6, the capability indication apparatus 600 includes a sending module 601.

The sending module 601 is configured to send capability support indication information to a network device, where the capability support indication information indicates a condition of a terminal being capable of supporting full-duplex communication.

In an embodiment, the capability support indication information indicates at least one of: whether supporting the full-duplex communication; whether supporting a dynamic subband indication; whether supporting the full-duplex communication in a granularity of a symbol within a time domain; or whether supporting semi-static communication in a dynamic flexible symbol.

In an embodiment, whether supporting the dynamic subband indication includes at least one of: whether supporting a dynamic uplink subband indication; or whether supporting a dynamic downlink subband indication.

In an embodiment, the apparatus 600 further includes: a processing module (not shown), configured to adjust, when supporting the dynamic uplink subband indication, a configuration of an uplink subband according to first dynamic adjustment information sent by the network device; and/or, adjust, when supporting the dynamic downlink subband indication, a configuration of a downlink subband according to second dynamic adjustment information sent by the network device.

In an embodiment, whether supporting the full-duplex communication in a granularity of a symbol within a time domain includes at least one of: whether supporting the full-duplex communication in an uplink symbol; or whether supporting the full-duplex communication in a downlink symbol.

In an embodiment, the apparatus 600 further includes: a receiving module (not shown), configured to receive, when supporting the full-duplex communication in the uplink symbol, downlink information in the uplink symbol according to first scheduling information sent by the network device; and/or a sending module, configured to send, when supporting the full-duplex communication in the downlink symbol, uplink information in the downlink symbol according to second scheduling information sent by the network device.

In an embodiment, whether supporting the semi-static communication in the dynamic flexible symbol includes at least one of: whether supporting sending semi-static uplink information in the dynamic flexible symbol, or whether supporting receiving semi-static downlink information in the dynamic flexible symbol.

In an embodiment, the apparatus 600 further includes: a receiving module (not shown), configured to receive, when supporting receiving the semi-static downlink information in the dynamic flexible symbol, the semi-static downlink information in the dynamic flexible symbol according to second indication information sent by the network device; and/or the sending module, configured to send, when supporting sending the semi-static uplink information in the dynamic flexible symbol, the semi-static uplink information in the dynamic flexible symbol according to first indication information sent by the network device.

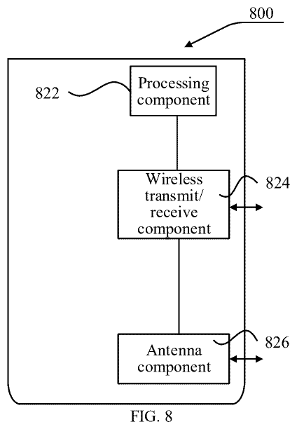

FIG. 7 is a schematic block diagram of a capability determination apparatus 700 shown according to an embodiment of the present disclosure. The capability determination apparatus 700 shown in this embodiment may be a network device or an apparatus formed by modules in a network device. The network device may communicate with a terminal. The terminal includes but is not limited to a communication apparatus, such as a mobile phone, a tablet computer, a wearable device, a sensor, an Internet of Things device, etc. The network device includes but is not limited to a network device, such as a base station, a core network, etc., in a communication system, such as 4G, 5G, 6G, etc.

As shown in FIG. 7, the capability determination apparatus 700 includes a processing module 701.

The processing module 701 is configured to determine, according to a capability support indication information sent by a terminal, a condition of the terminal being capable of supporting full-duplex communication.

In an embodiment, the capability support indication information indicates at least one of: whether supporting the full-duplex communication; whether supporting a dynamic subband indication; whether supporting the full-duplex communication in a granularity of a symbol within a time domain; or whether supporting semi-static communication in a dynamic flexible symbol.

In an embodiment, whether supporting the dynamic subband indication includes at least one of: whether supporting a dynamic uplink subband indication; or whether supporting a dynamic downlink subband indication.

In an embodiment, the apparatus 700 further includes: a sending module (not shown), configured to send, when determining that the terminal supports the dynamic uplink subband indication, first dynamic adjustment information to the terminal, where the first dynamic adjustment information is for adjusting a configuration of an uplink subband; and/or send, when determining that the terminal supports the dynamic downlink subband indication, second dynamic adjustment information to the terminal, where the second dynamic adjustment information is for adjusting a configuration of a downlink subband.

In an embodiment, whether supporting the full-duplex communication in a granularity of a symbol within a time domain includes at least one of: whether supporting the full-duplex communication in an uplink symbol; or whether supporting the full-duplex communication in a downlink symbol.

In an embodiment, the apparatus 700 further includes: a sending module (not shown), configured to send, when determining that the terminal supports the full-duplex communication in the uplink symbol, first scheduling information to the terminal, where the first scheduling information is for scheduling the terminal to receive downlink information in the uplink symbol; and/or send, when determining that the terminal supports the full-duplex communication in the downlink symbol, second scheduling information to the terminal, where the second scheduling information is for scheduling the terminal to receive uplink information in the downlink symbol.

In an embodiment, whether supporting the semi-static communication in the dynamic flexible symbol includes at least one of: whether supporting sending semi-static uplink information in the dynamic flexible symbol, or whether supporting receiving semi-static downlink information in the dynamic flexible symbol.

In an embodiment, the apparatus 700 further includes: a sending module (not shown), configured to send, when determining that the terminal supports sending the semi-static uplink information in the dynamic flexible symbol, first indication information to the terminal, where the first indication information is for instructing the terminal to send the semi-static uplink information in the dynamic flexible symbol; and/or send, when determining that the terminal supports receiving the semi-static downlink information in the dynamic flexible symbol, second indication information to the terminal, where the second indication information is for instructing the terminal to receive the semi-static downlink information in the dynamic flexible symbol.

The specific manners in which each of the modules of the apparatuses in the embodiments perform operations have been described in detail in the embodiments related to the methods, and will not be explained here in detail.

Since the embodiments of the apparatuses substantially corresponds to the embodiments of the methods, and the related contents may refer to the description of the embodiments of the methods. The apparatus embodiments described are only schematic. The modules explained as separate components may be or may not be physically separated, and the components displayed as modules may be or may not be physical modules, that is, they may be located in one place or may be distributed across multiple network modules. A part or all of modules may be selected according to actual needs to achieve the purpose of the solutions in these embodiments. Those skilled in the art may understand and implement other embodiments without a creative work.

An embodiment of the present disclosure further provides a communication apparatus, including: a processor; and a memory storing a computer program, where when the computer program is executed by the processor, the capability indication method of any one of the embodiments is implemented.

An embodiment of the present disclosure further provides a communication apparatus, including: a processor; and a memory storing a computer program, where when the computer program is executed by the processor, the capability determination method of any one of the embodiments is implemented.

An embodiment of the present disclosure further provides a computer-readable storage medium, configured to store a computer program; where when the computer program is executed by the processor, the capability indication method of any one of the embodiments is implemented.

As shown in FIG. 8, FIG. 8 is a schematic block diagram of a capability determination apparatus 800 shown according to an embodiment of the present disclosure. The apparatus 800 may be provided as a base station. Referring to FIG. 8, the apparatus 800 includes a processing component 822, a wireless transmit/receive component 824, an antenna component 826, and a signal processing part specific to a wireless interface. The processing component 822 may further include one or more processors. One processor of the processing component 822 may be configured to implement the capability determination method of any one of the embodiments.

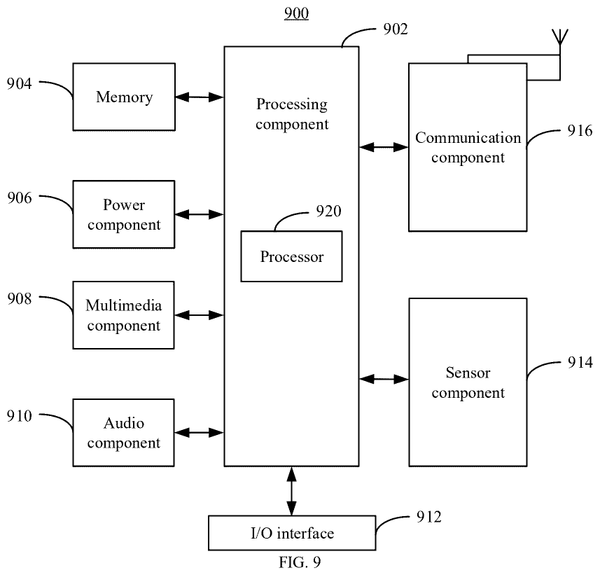

FIG. 9 is a schematic block diagram of a capability indication apparatus 900 shown according to an embodiment of the present disclosure. For example, the apparatus 900 may be a mobile phone, a computer, a digital broadcast terminal, a message transceiving device, a game console, a tablet device, a medical device, a fitness device, a personal digital assistant, etc.

Referring to FIG. 9, the apparatus 900 may include one or more of the following components: a processing component 902, a memory 904, a power component 906, a multimedia component 908, an audio component 910, an input/output (I/O) interface 912, a sensor component 914, and a communication component 916.

The processing component 902 typically controls the overall operation of the apparatus 900, such as operations associated with display, phone calls, data communication, camera operations, and recording operations. The processing component 902 may include one or more processors 920 to execute instructions to complete all or part of the steps in the capability indication method. Additionally, the processing component 902 may include one or more modules to facilitate interaction between the processing component 902 and other components. For example, the processing component 902 may include a multimedia module to facilitate interaction between the multimedia component 908 and the processing component 902.

The memory 904 is configured for storing various types of data to support operations of the apparatus 900. Examples of such data include instructions, contact data, phonebook data, messages, pictures, videos, etc., for any application program or method operating on the apparatus 900. The memory 904 may be realized by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 906 provides power to various components of the apparatus 900. The power component 906 may include a power supply management system, one or more power supplies, and other components that are associated with generating, managing, and distributing power for the apparatus 900.

The multimedia component 908 includes a screen providing an output interface between the apparatus 900 and the user. In some embodiments, the screen may include a liquid crystal display (LCD) and a touch panel (TP). If the screen includes the touch panel, the screen may be implemented as a touch screen, to receive an input signal from the user. The touch panel includes one or more touch sensors to sense the touch, the slide, and the gesture on the touch panel. The touch sensor may not only sense a boundary of the touch or slide action, but also detect a duration and pressure related to the touch or slide operation. In some embodiments, the multimedia component 908 includes a front facing camera and/or a rear facing camera. When the apparatus 900 is in an operation mode, such as a shooting mode or a video mode, the front facing camera and/or the rear facing camera may receive external multimedia data. Each of the front facing camera and rear facing camera may be a fixed optical lens system or has a focal length and an optical zoom capability.

The audio component 910 is configured to output and/or input audio signals. For example, the audio component 910 includes a microphone (MIC). The microphone is configured for receiving external audio signals when the apparatus 900 is in the operating mode, such as a call mode, a recording mode, and a speech recognition mode. The received audio signals may be further stored in the memory 904 or sent via the communication component 916. In some embodiments, the audio component 910 also includes a speaker for outputting the audio signals.

The I/O interface 912 provides an interface between the processing component 902 and peripheral interface modules. The peripheral interface modules may be keyboards, click wheels, buttons, etc. These buttons may include but are not limited to: a home button, a volume button, a start button, and a lock button.

The sensor component 914 includes one or more sensors to provide various aspects of state assessment for the apparatus 900. For example, the sensor component 914 may detect an open/closed state of the apparatus 900, relative positioning of components that are for example a display and keypad of the apparatus 900. The sensor component 914 may also detect a position change of the apparatus 900 or of a component of the apparatus 900, presence or absence of the user contacting with the apparatus 900, an orientation or acceleration/deceleration of the apparatus 900, and a temperature change of the apparatus 900. The sensor component 914 may include a proximity sensor configured to detect the presence of nearby objects without any physical contact. The sensor component 914 may also include a light sensor, such as a CMOS or CCD image sensor, for use in an imaging application. In some embodiments, the sensor component 914 may also include an acceleration sensor, a gyroscope sensor, a magnetic sensor, a pressure sensor, or a temperature sensor.

The communication component 916 is configured for facilitating wired or wireless communication between the apparatus 900 and other devices. The apparatus 900 may access a wireless network based on a communication standard, such as WiFi, 2G, 3G, 4G LTE, 5G NR, or a combination of them. In an exemplary embodiment, the communication component 916 receives, via a broadcast channel, a broadcast signal or broadcast related information from an external broadcast management system. In an exemplary embodiment, the communication component 916 further includes a near-field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the apparatus 900 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the capability indication method.

In an exemplary embodiment, a non-transitory computer-readable storage medium including instructions is also provided, such as the memory 904 including the instructions. The instructions can be executed by the processor 920 of the apparatus 900 to complete the capability indication method. For example, the non-transitory computer-readable storage medium may be a ROM, a random access memory (RAM), a CD-ROM, a magnetic tape, a floppy disk, an optical data storage device, etc.

According to an eighth aspect of the embodiments of the present disclosure, a capability indication apparatus is provided. The apparatus includes: a sending module, configured to send capability support indication information to a network device, where the capability support indication information indicates a condition of a terminal being capable of supporting full-duplex communication.

According to a ninth aspect of the embodiments of the present disclosure, a capability determination apparatus is provided. The apparatus includes: a processing module, configured to determine, according to a capability support indication information sent by a terminal, a condition of the terminal being capable of supporting full-duplex communication.

Those skilled in the art will easily come up with other implementation solutions of the present disclosure after considering the specification and practicing the present disclosure disclosed herein. The present disclosure aims to cover any variations, uses, or adaptive changes of the present disclosure, which follow general principles of the present disclosure and include common knowledge or customary technical means in the art not disclosed in the present disclosure. The specification and embodiments are only considered exemplary, and the true scope and spirit of the present disclosure are indicated by the following claims.

It should be understood that the present disclosure is not limited to the precise structure described and shown in the accompanying drawings, and various modifications and changes may be made without departing from its scope. The scope of the present disclosure is limited only by the appended claims.

It should be noted that the relationship terms used herein, such as “first”, “second” and the like are only to distinguish one entity or operation from another entity or operation, but do not necessarily require or imply that there is any actual relationship or order between these entities or operations. The terms “include”, “comprise”, or any variants thereof are intended to cover a non-exclusive inclusion, such that processes, methods, articles, or devices, including a series of elements, include not only those elements that have been listed, but also other elements that are not specifically listed or the elements intrinsic to these processes, methods, articles, or devices. Without further limitations, elements limited by the wording “include(s) a/an.” or “comprise(s) a/an . . . ” do not exclude additional identical elements in the processes, methods, articles or devices, including the listed elements.

The method and apparatus provided by the embodiments of the present disclosure are described in detail, specific examples are applied herein to describe the principles and implementations of the present disclosure, and the description of the embodiments is only used to help understand the method of the present disclosure and the core idea thereof, meanwhile, for those skilled in the art, according to the idea of the present disclosure, there will be changes in the specific implementations and application scope. In summary, the content of the present disclosure should not be construed as limiting the present disclosure.

1. A capability indication method, performed by a terminal and comprising:
sending capability support indication information to a network device, wherein the capability support indication information indicates a condition of the terminal being capable of supporting full-duplex communication.

2. The method of claim 1, wherein the capability support indication information indicates at least one of:
whether being capable of supporting the full-duplex communication;
whether being capable of supporting a dynamic subband indication;
whether being capable of supporting the full-duplex communication in a granularity of a symbol within a time domain; or
whether being capable of supporting semi-static communication in a dynamic flexible symbol.

3. The method of claim 2, wherein whether being capable of supporting the dynamic subband indication comprises at least one of:
whether being capable of supporting a dynamic uplink subband indication; or
whether being capable of supporting a dynamic downlink subband indication.

4. The method of claim 3, further comprising at least one of:
adjusting, when being capable of supporting the dynamic uplink subband indication, a configuration of an uplink subband according to first dynamic adjustment information sent by the network device; or
adjusting, when being capable of supporting the dynamic downlink subband indication, a configuration of a downlink subband according to second dynamic adjustment information sent by the network device.

5. The method of claim 2, wherein whether being capable of supporting the full-duplex communication in the granularity of the symbol within the time domain comprises at least one of:
whether being capable of supporting the full-duplex communication in an uplink symbol; or
whether being capable of supporting the full-duplex communication in a downlink symbol.

6. The method of claim 5, further comprising at least one of:
receiving, when being capable of supporting the full-duplex communication in the uplink symbol, downlink information in the uplink symbol according to first scheduling information sent by the network device; or
sending, when being capable of supporting the full-duplex communication in the downlink symbol, uplink information in the downlink symbol according to second scheduling information sent by the network device.

7. The method of claim 2, wherein whether being capable of supporting semi-static communication in a dynamic flexible symbol comprises at least one of:
whether being capable of supporting sending semi-static uplink information in the dynamic flexible symbol; or
whether being capable of supporting receiving semi-static downlink information in the dynamic flexible symbol.

8. The method of claim 7, further comprising at least one of:
sending, when being capable of supporting sending the semi-static uplink information in the dynamic flexible symbol, the semi-static uplink information in the dynamic flexible symbol according to first indication information sent by the network device; or
receiving, when being capable of supporting receiving the semi-static downlink information in the dynamic flexible symbol, the semi-static downlink information in the dynamic flexible symbol according to second indication information sent by the network device.

9. A capability determination method, performed by a network device and comprising:
determining, according to a capability support indication information sent by a terminal, a condition of the terminal being capable of supporting full-duplex communication.

10. The method of claim 9, wherein the capability support indication information indicates at least one of:
whether being capable of supporting the full-duplex communication;
whether being capable of supporting a dynamic subband indication;
whether being capable of supporting the full-duplex communication in a granularity of a symbol within a time domain; or
whether being capable of supporting semi-static communication in a dynamic flexible symbol.

11. The method of claim 10, wherein whether being capable of supporting the dynamic subband indication comprises at least one of:
whether being capable of supporting a dynamic uplink subband indication; or
whether being capable of supporting a dynamic downlink subband indication.

12. The method of claim 11, further comprising at least one of:
sending, when determining that the terminal is capable of supporting the dynamic uplink subband indication, first dynamic adjustment information to the terminal, wherein the first dynamic adjustment information is for adjusting a configuration of an uplink subband; or
sending, when determining that the terminal is capable of supporting the dynamic downlink subband indication, second dynamic adjustment information to the terminal, wherein the second dynamic adjustment information is for adjusting a configuration of a downlink subband.

13. The method of claim 10, wherein whether being capable of supporting the full-duplex communication in the granularity of the symbol within the time domain comprises at least one of:
whether being capable of supporting the full-duplex communication in an uplink symbol; or
whether being capable of supporting the full-duplex communication in a downlink symbol.

14. The method of claim 13, further comprising at least one of:
sending, when determining that the terminal is capable of supporting the full-duplex communication in the uplink symbol, first scheduling information to the terminal, wherein the first scheduling information is for scheduling the terminal to receive downlink information in the uplink symbol; or
sending, when determining that the terminal is capable of supporting the full-duplex communication in the downlink symbol, second scheduling information to the terminal, wherein the second scheduling information is for scheduling the terminal to receive uplink information in the downlink symbol.

15. The method of claim 10, wherein whether being capable of supporting semi-static communication in the dynamic flexible symbol comprises at least one of:
whether being capable of supporting sending semi-static uplink information in the dynamic flexible symbol; or
whether being capable of supporting receiving semi-static downlink information in the dynamic flexible symbol;
wherein the method further comprises at least one of:
sending, when determining that the terminal is capable of supporting sending the semi-static uplink information in the dynamic flexible symbol, first indication information to the terminal, wherein the first indication information is for instructing the terminal to send the semi-static uplink information in the dynamic flexible symbol; or
sending, when determining that the terminal is capable of supporting receiving the semi-static downlink information in the dynamic flexible symbol, second indication information to the terminal, wherein the second indication information is for instructing the terminal to receive the semi-static downlink information in the dynamic flexible symbol.

16. (canceled)

17. A capability indication system, comprising a terminal and a network device, wherein the terminal is configured to send capability support indication information to the network device, and
the network device is configured to determine, according to a capability support indication information sent by the terminal, a condition of the terminal being capable of supporting full-duplex communication.

18-19. (canceled)

20. A communication apparatus, comprising:
a processor; and
a memory storing a computer program, and
wherein when the computer program is executed by the processor, the capability indication method of claim 1 is implemented.

21. A communication apparatus, comprising:
a processor; and
a memory storing a computer program, and
wherein when the computer program is executed by the processor, the capability determination method of claim 9 is implemented.

22. A non-transitory computer-readable storage medium, storing a computer program; wherein when the computer program is executed by a processor, the capability indication method of claim 1 is implemented.

23. A non-transitory computer-readable storage medium, storing a computer program; wherein when the computer program is executed by a processor, the capability determination method of claim 9 is implemented.
